(19) United States
(12) Patent Application Publication
(10) Pub. No.: US 2007/0143520 A1
(43) Pub. Date: Jun. 21, 2007

(54) Bridge, computer system and method for initialization

(76) Inventors: Shan-Kai Yang, Taipei City (TW); Lei Ding, Shanghai (CN); Li-Jian Zhao, Shanghai (CN)

Correspondence Address: RABIN & Berdo, PC, 1101 14TH STREET, NW, SUITE 500, WASHINGTON, DC, 20005, US

(21) Appl. No.: 11/378,386

(22) Filed: Mar. 20, 2006

(30) Foreign Application Priority Data
Dec. 16, 2005 (TW) 94144627

(51) Int. Cl. G06F 13/36

(52) U.S. Cl. 710/306

(57) ABSTRACT

An indicator pin of an input/output controller is used to identifying whether a processor or a bridge is configured in a processor. When a predetermined voltage level of the indicator pin is confirmed, a base input/output system of the computer system renews a coherent/non-coherent HyperTransport link table. Then an initialization procedure is performed in accordance with the renewed coherent/non-coherent HyperTransport link table.

### BACKGROUND

1. Field of Invention

The present invention relates to a computer system used in processing the electronic data, and in particular to a computer system having a bridge module plugged into the socket of a processor, thus connecting it in series with a Bus.

2. Related Art

In a computer system, the most essential constituting portion is the motherboard, which is used to carry and support the various electronic components, among them the processor is the most important element, such as the central processing unit (CPU), which is responsible for the major task of various data operations, and thus be considered as the core of the entire computer system. In order to handle the increasingly complicated and sophisticated data processing, the capability of a single processor sometimes is not sufficient to cope with the requirement of operation, thus bringing about the emergence of the multi-processor system having two or more processors on the same motherboard.

In the following description, the double processor system is taken as an example for explanation. On its motherboard two sockets are provided for the two processors to be plugged in. Wherein, the operation of parallel multiplexed processing is utilized to raise the efficiency of data processing. In the above-mentioned structure, one configuration is that, the connection between two processors are connected through a Bus, thus in every processor there is a corresponding chipset, and the connection between two chipsets is achieved through a Bus to perform the specific functions.

However, for such a framework, when the motherboard used for double processors is only plugged on with one processor, then in addition to the problem of increased load, the related functions of a chipset connected to vacant processor socket, such as the various functions of PCI expansion card connected to the PCI bridge chip may not be utilized at all, thus resulting in tremendous waste and inconvenience. This conditions often happen in the situations that one of the two processors is removed for application in low operation requirement, or one of the two processors is removed for reparation.

Usually, when the functions of the idle chipset for the removed processor are desired to be used, then the idle chipset must first be connected to the remaining processor. For similar arrangement, please refer to the dual processor system disclosed in U.S. Pat. No. 6,618,783, wherein, when one Input/Output processor is out of operation, then other predetermined cross-coupled I/O processor is used to take over the control of the operation of the originally connected PCI Input/Output Card.

However, the arrangement of such a predetermined cross-coupled framework will inevitably add to the complexity of the circuit layout. In addition, when the socket of a processor is idle, the bus connected to it must be further processed to ensure proper operation of the system. For example, if bus termination operation has not been performed, then the continuously transmitted signals will be reflected back to the original transmitting device at the end of the bus since they have not been received by the idle processor, thus creating signal interference. This phenomenon tends to become even more serious in high speed bus. Consequently, the predetermined cross-coupled framework must be coupled with bus termination processing to ensure proper operation of the system. It is not a very satisfactory solution.

Moreover, in the multi-processor system such as an 8 processors system, the devoid of any of the processors would cause the termination of connections with other processors or the increase of transmission delay. Thus, the afore-mentioned predetermined cross-coupled technology can not solve this problem due to the restriction of predetermined number of transmission channels of the respective processors.

Though it is theoretically feasible to design a bridge module plugged onto the socket of a processor, thus connecting the two buses originally connected to the same socket of the processor. However, the question as to how the computer system is utilized to determine the device plugged onto the socket is a processor or a bridge module, and how the initialization procedure of the computer system having the plugged on bridge module is to be adjusted is an important task to be achieved in this field.

### SUMMARY OF THE INVENTION

In view of the problems and shortcomings of the prior art, the present invention provides a computer system and its bridge module, which can be used to maintain the communication between processor and chipset, processor and I/O controller or processor and sub-system, without having to install additional processors or change the framework of the computer system.

According to one aspect of the computer system disclosed by the invention, the computer system includes: a first processor socket and a second processor socket, a first bus and a second bus, the processors, the bridge modules, and the indicator pins of the input/output controller. In the above structure; the first bus is electrically connected to the first processor socket and the second processor socket; the second bus is electrically connected to the second processor socket; the processor is plugged into the first processor socket, thus electrically connecting to the first bus; the bridge module is connected to the second processor socket, thus connecting electrically to the first and second buses, so as to make the processor electrically connected to the second bus through the first bus and the bridge module; the indicator pins of the input/output controller is provided with a predetermined voltage level when the bridge module is plugged onto the pins of the second processor, and is provided for identification by the basic input/output system (BIOS) of the computer system.

In addition, the bridge module disclosed by the invention is plugged onto the second processor socket on the motherboard, and the second processor socket is electrically connected to the first bus and the second bus. The bridge module includes: a body of the printed-circuit-board (PCB), a bridge determination contact member, a ground contact member, a first and a second electrical contact members. Wherein, the body of the PCB is used for installing the second processor socket; the bridge determination contact member and the ground contact member is disposed on the body of PCB, and connected to each other by circuit connection; the first and second electric contact members are disposed on the body of PCB and are used to provide electric connection with the second processor socket to form communication with the first and second buses respectively. The first and second electric contact members are provided with certain definitions corresponding to each other and are connected by circuit connection.

The invention further provides an initialization method for initializing the above-mentioned computer system, which is executed through the BIOS of the computer system, including the following steps: Firstly, determine if the voltage level of an indicator pin on the input/output controller is at or exceeds a predetermined voltage level. Then, update a coherent HyperTransport link table and/or a non-coherent HyperTransport link table in a BIOS. And finally, execute the initialization procedure according to the updated coherent HyperTransport link table and/or a non-coherent HyperTransport link table.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus are not limitative of the invention, and wherein:

FIG. 1 is a schematic diagram of applying a bridge module to a dual processor computer system according to an embodiment of the present invention;

FIG. 2A is an exploded view of a bridge module connected to a processor socket according to an embodiment of the invention;

FIG. 2B is another exploded view of a bridge module connected to a processor socket according to another embodiment of the invention;

FIG. 3 is a schematic diagram of another bridge module according to still another embodiment of the invention;

FIG. 4 is a schematic diagram of applying two bridge modules to a four-processor computer system according to another embodiment of the invention;

FIG. 5 is a schematic diagram of applying a bridge module to the two-processor computer system according to yet another embodiment of the invention;

FIG. 6A is a schematic diagram of applying a bridge module to the two-processor computer system according to still another embodiment of the invention;

FIG. 6B is a schematic diagram indicating the utilization of the general purpose input/output (GPIO) pin connection in the structure shown in FIG. 6A; and

FIG. 7 is a flowchart indicating the steps of the method of initializing the computer system having the plugged on bridge module according to an embodiment of the invention.

### DETAILED DESCRIPTION OF THE INVENTION

The purpose, construction, features, and functions of the invention can be appreciated and understood more thoroughly through the following detailed description with reference to the attached drawings.

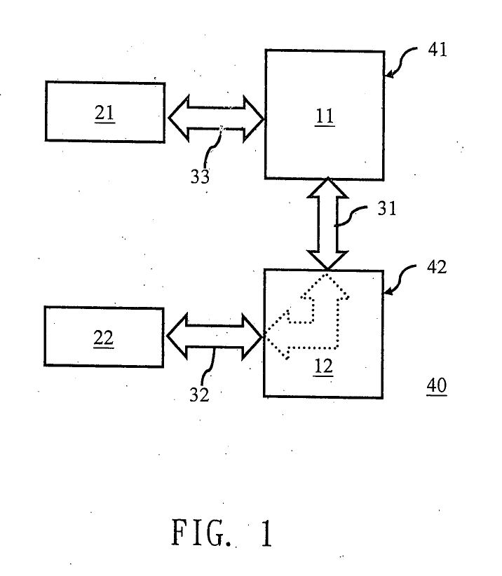

Before going into details of the system and method used for initializing the bridge module plugged onto the processor socket, the bridge module to be initialized is first described. For better understanding of the bridge module, the portions related to identifying the bridge module, and the adjustment portion of the initialization procedure for the computer system are omitted in FIGS. 1 to 4, so as not to obscure the essence of the bridge module.

Refer to FIG. 1 for a schematic diagram of applying a bridge module to a dual processor computer system according to an embodiment of the present invention. As shown in FIG. 1, the dual processor system includes: a motherboard 40, a first bus 31, a second bus 32, a third bus 33, a processor 11, and a bridge module 12. A first processor socket 41, a second processor socket 42, a first chipset 21, and a second chipset 22 are provided on a motherboard 40. Processor 11 is plugged onto the first processor socket 41. A bridge module 12 is used to replace another processor 11 and plugged onto the second processor socket 42, and connected electrically indirectly to the first bus 31 and second bus 32, so as to make the first bus 31 in communication with the second bus 32. In the above-mentioned structure, the processor 11 may be: a central processing unit (CPU); the first chipset 21 and the second chipset 22 may be: a North Bridge, a South Bridge, a bridge chip incorporating a North Bridge and a South Bridge, or an I/O bridge chip.

The implementation of the first bus 31, the second bus 32 and the third bus 33, which are essentially the dual unidirectional point-to-point links, are in compliance with the same data transmission protocol, for example, the HyperTransport protocol. Thus, this kind of bus can be utilized in the data transmission of a processor, a chipset, an Input/Output controller or a subsystem (in general, a second motherboard, which is provided with a plurality of expansion buses or other expansion functions). As such, the first bus 31 is disposed between the first processor socket 41 and the second processor socket 42, so that the processor 11 is electrically connected to the bridge module 12. While the second bus 32 is disposed between the second processor socket 42 and the chipset 22, and is used to connect the bridge module 12 and the chipset 22. And the third bus 33 is disposed between the first processor socket 41 and the chipset 21, so that the processor 11 is used to form communication with the chipset 12. Therefore, in addition to forming communication with the first chipset 21 through the third bus 33, so that the functions of processor 11 may be fully utilized, the processor 11 can also be used to form communication with the second chipset 22 through the first bus 31, bridge module 12, and the second bus 32, thus allowing the functions chipset 22 to be fully utilized without having to install the second processor.

As to the technical requirement imposed on the first bus 31 and second bus 32 that are both connected to the second processor socket 42, in addition to the requirement that both of the two buses must transmit data in compliance with the specific data transmission specification, the first bus 31 and the bus 32 are of equal status relative to the Basic Input/Output System (BIOS), and transmit data without difference of master/slave. In this case, the Opteron™ MP processor of AMD (Advanced Micro Devices) is taken as an example, which is used to support three groups of transmission bus, and their statuses relative to BIOS is equal, and there is no restriction specifying that which bus is connected to which processor or which chipset. As such, under the condition that the processor 11 is plugged into the second processor socket 42, the first bus 31 may serve as a connection between the two processors 11; meanwhile, in case that a bridge module 12 is plugged into the second processor socket 42, the first bus 31 is connected to the second bus 32 to serve as a link between the processor 11 plugged into the first processor socket 41 and the chipset 22.

Furthermore, the bridge module 12 can be a circuit board module, which in order to be plugged into the second processor socket 42, is provided with the same package as the processor 11. Naturally, in the framework of not changing the motherboard 40, the first processor socket 41 and the second processor socket 42 may have the same specification. If the specification of the second processor socket 42 is changed due to special design, then the bridge module 12 may not have to be the same specification as does the processor 11, it may operate well by just being plugged into the second processor socket 42 and connected to certain specifically defined pins. The details of which will be described as follows.

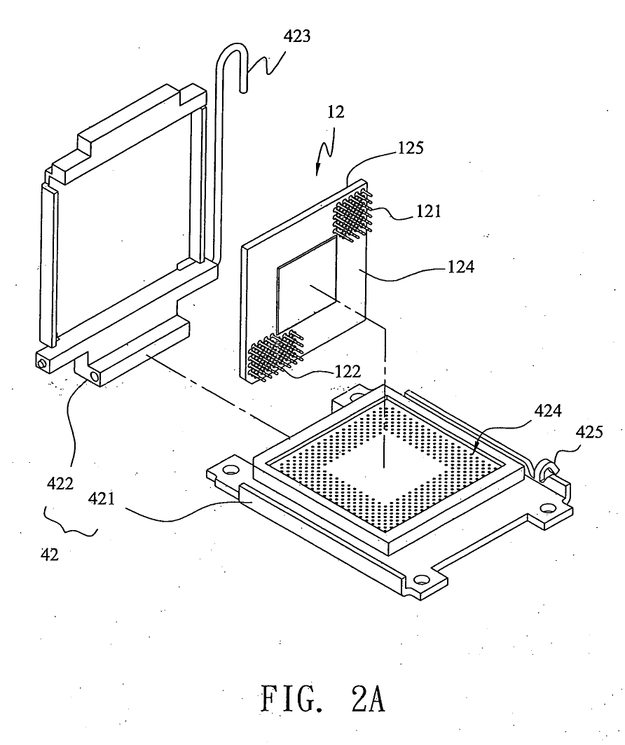

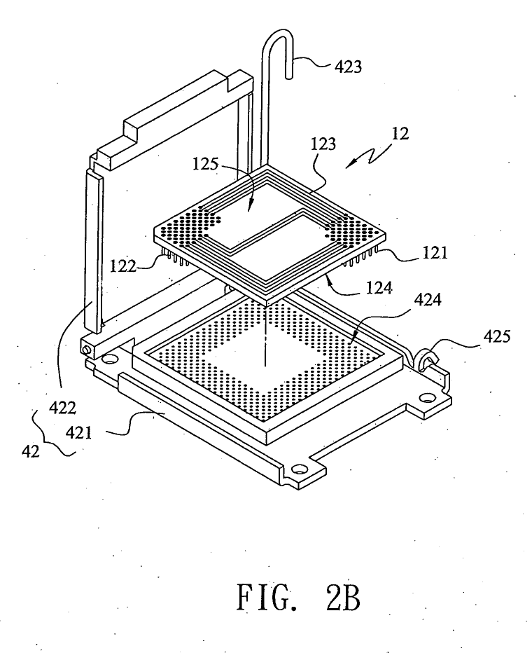

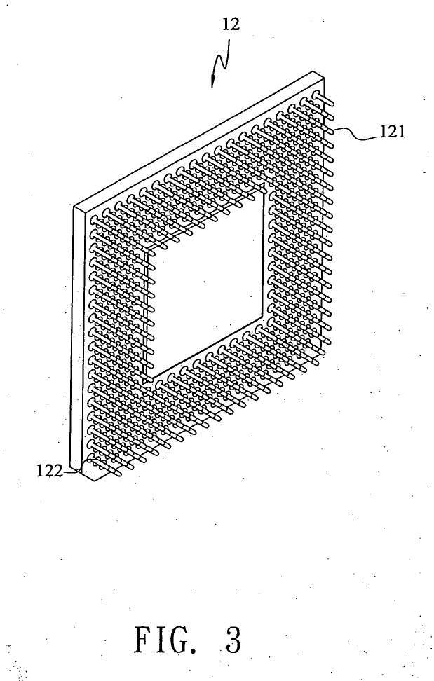

Next, refer to FIGS. 2A to 2B for the explanation of connecting the bridge module to the processor socket of the computer system of the present invention. FIG. 2A is an exploded view of a bridge module connected to a processor socket according to an embodiment of the invention. FIG. 2B is another exploded view of a bridge module connected to a processor socket according to another embodiment of the invention. As shown in FIG. 2A, the bridge module 12 is a circuit board module having a processor packaging structure and is disposed on a bottom seat 421 of a second processor socket 42, and is fixed and secured by a card arm 423 of upper hood 422 and a card hook 425 of the bottom seat 421. A first surface 124 of the PCB body (not marked) of the bridge module 12 is provided with a plurality of protruding first electric contact members 121 and second electric contact members 122, used for inserting into a plurality of corresponding inserting holes 424 on the bottom seat 421. In the respect insertion holes 424 are imbedded with electric contact (not shown), used for electrically connecting the first electric contact 121 and the second electric contact 122 to the traces (not shown) of the first bus 31 and the second bus 32 (FIG. 1) on the motherboard 40. The respective corresponding first electric contact 121 and second electric contact 122 is connected by making use of circuit 123 of the second surface 125, so that the first bus 31 and second bus 32 are connected to each other as shown in FIG. 1. Basically, the first and second electric contact members 121,122 are provided with certain definitions corresponding to each other and are connected by circuit connection. The position of circuit 123 relative to that of the connected first and second electric contact members 121,122 is not restricted. Thus, circuit 123 may be provided on the same surface or different surface with first and second electric contact members 121,122. If the multi-layer circuit board is utilized, then circuit 123 may not appear on the surface of bridge module 12. In addition, if the second processor socket 42 remains intact, then the first electric contact 121 and the second electric contact 122 can be metallic pins, and their pitches and lengths are the same as those of the processor 11. Naturally, the entire surface of the first surface may be designed and provided with pins (FIG. 3), their number is the same as that of processor 11, however, its usage is only restricted to circuit connection.

Moreover, the second processor socket 42 as shown in FIGS. 2A & 2B are for illustration purpose only, however it is not intended to restrict the scope and configuration of the bridge module 12. Nevertheless, its pins configuration are corresponding to that of bridge module 12 having Pin Grid Array (PGA). In case that the bridge module is used to replace a processor having pins configuration of Land Grid Array (LGA), then the bridge module must be provided with a plurality of metal pads having LGA configuration as the electric contact. Correspondingly, the bottom seat of the second processor socket must be provided with a plurality of protruding electric contact for connecting to the metal pads.

Furthermore, as to the definition of the first electric contact 121 and the second electric contact 122, the bus in compliance with the HyperTransport protocol such as the first bus 31 and second bus 32 are used as examples, they must likewise be in compliance with the HyperTransport protocol. Similarly, for the electric contact on the second processor socket 42 it is the same case. Herein, the sample of names and positions of the processor pins of attachment 1 is taken as an example, wherein, the positions marked with HT LINK0, HT LINK1, HT LINK2 are the respective pin positions of three buses supported by a processor. In case that a processor is plugged onto a processor socket, then the three buses are operational. However, in case that a bridge module is plugged onto a processor socket, then two buses may be chosen to be operational, thus only pins HT LINK0, HT LINK1 have to be connected to the electric circuit, so the pins defined by HT LINK0, HT LINK1 are first and second electric contact members 121 and 122 respectively. However, it worthy to note that, the number of bus the bridge module is capable of connecting is restricted by the predetermined number of transmission ports of a processor. Thus, in case the processor is capable of supporting three or four transmission ports, then the bridge module may be used to connect to one or more pairs of buses.

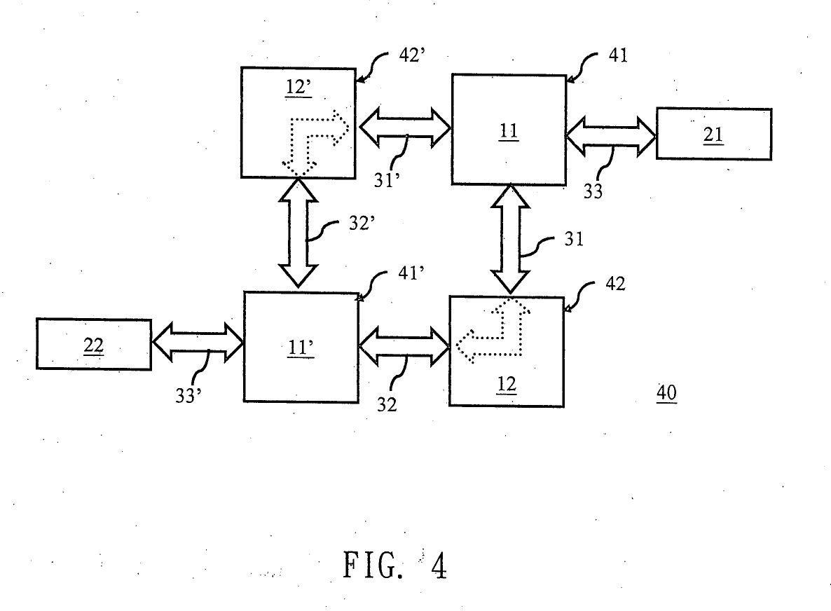

Then, refer to FIG. 4 for a schematic diagram of applying two bridge modules to a four-processor computer system according to another embodiment of the present invention for more detailed description of the above-mentioned situation. As shown in FIG. 4, the two bridge modules 12, 12′ plugged onto the sockets of two second processors 42, 42′ are connected respectively to the first buses 31, 31′ and the second buses 32, 32′, so as to link the two processors 11, 11′ plugged onto the sockets 41, 41′ of the first processor. Since the two processors 11, 11′ both provide the support for three bus transport ports, thus they can be linked to two chipsets 21, 22 through the third buses 33, 33′ respectively. In addition to being used to connect between chipsets, the bridge modules can be used for connection between processors.

Similarly, the computer systems having more than eight processors may be handled in a similar manner. They belong to the varied embodiments of the present invention, and will not be repeated here for brevity. Further, in case that the transmission latency between processors is defined as the least number of buses that must be traversed for communications between any two processors, then the replacement of the processors with bridge module as done in the invention can be utilized to avoid any transmission latency caused by the devoid or lack of processors. In the case as shown in FIG. 4, the transmission latency of the two processor 11 is decreased rather than increased, that is because after initialization of the installed bridge modules, the first bus 31 and the second bus 32 connected to the bridge module 12 essentially function as the same bus, thus making the related transmission latency=1.

In the above description, the one or more pairs of buses connected to the bridge module are not restricted to those in compliance with the HyperTransport protocol. The bridge module may be applied to any dual unidirectional point-to-point buses having mutually equal statuses and transmit data without difference of master/slave that are in compliance with the same data transmission protocol. Moreover, in addition to being disposed between two processors, a processor and a chip set for communication purpose as disclosed above, the bridge module may also be utilized to bridge between the processor and input/output controller or the processor and the sub-system by making use of the appropriate buses.

In the following, the computer system having the above-mentioned bridge module and its initialization method will be described in detail.

The bridge module or processor plugged onto the socket of the processor can be recognized and distinguished by the basic input/output system (BIOS), thus the General Purpose Input/Output (GPIO) pins on the Input/Output (I/O) controller such as the Southbridge, floppy disk controller or bus bridge chip can be used as the indicator pin, and the variations of its voltage level can be used by BIOS to distinguish between the bridge module and processor.

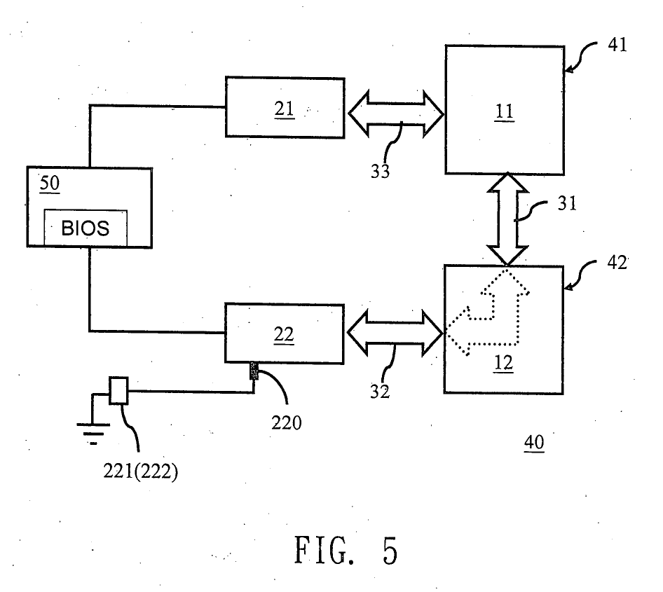

Firstly, refer to FIG. 5 for a schematic diagram of applying a bridge module to the two-processor computer system according to yet another embodiment of the present invention. As shown in FIG. 5, an indicator pin 220 (such as a general purpose input/output pin) is provided on a second chipset 22, which is electrically connected to a pin header 221. The pin header 221 is provided with at least two pins (not shown) for the jumper 222 to plugged on, wherein, at least one pin is connected to ground, and the other pin is electrically connected to a general purpose input/output pin 220. The basis input/output system (BIOS) is disposed on the system controller 50. The system controller 50 can be a special purpose controller having dedicated BIOS chip or built in BIOS, for example the Input/Output controller such as floppy disk controller. The system controller 50 is electrically connected to a first and a second chipsets 21 and 22, so as to get the various system data required by BIOS, including the voltage level state of general purpose input/output pin 220.

In real practice, in case that the bridge module 12 is plugged onto the second processor socket 42, the jumper 222 is plugged onto the pin header 221, so that the general purpose input/output pin 220 is connected to ground, thus it is at low voltage level or the “0” state; while in case that the bridge module 11 is plugged onto the second processor socket 42, the jumper 222 is so plugged that the general purpose input/output pin 220 is not connected to ground, thus it is at high voltage level or the “1” state. As such, these two 0/1 states of two different voltage levels are utilized by BIOS to distinguish that the device plugged onto the second processor socket is processor 11 or bridge module 12. Naturally, the pin header 221 may also connected to a high voltage, then the discrimination of the plugged on processor or bridge module is conducted in an opposite manner.

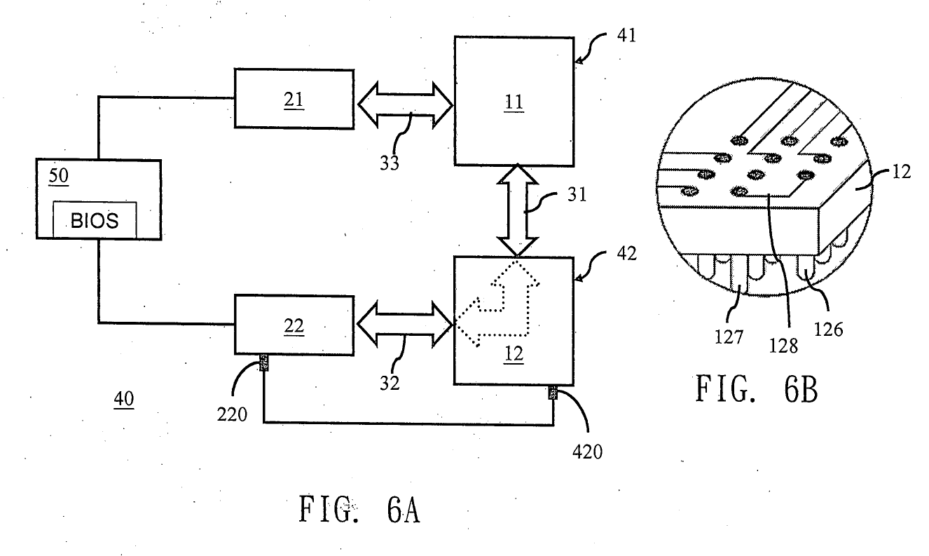

Next, refer to FIGS. 6A to 6B for a block diagram of applying a bridge module in a dual processor computer system by making use of the general purpose input/output pin according an embodiment of the present invention. As shown in FIG. 6A, the socket discrimination pin 420 such as the Power Supply Pin plugged onto the second processor socket 42 is connected to an indicator pin 220 of a second chipset 22. In the present embodiment, an Opteron MP processor of the AMD is taken as an example, thus, to the processor and socket, pin VDDA is originally used for Filtered PLL Supply Voltage, when the processor is plugged on, the corresponding pins of the processor and socket are at high voltage levels of state “1”. In this example, the pin corresponding to the bridge module 12 is used as a bridge determination pin 126, and the connection wire 128 is used as the circuit connection to the ground connection pin 127. The ground connection pin 127 is connected to ground through the second processor socket 42. Thus, upon installation, the bridge module 12, the bridge determination pin 126 and the socket determination pin 420 of the socket 42 of the second processor is at low voltage level of state “0”. As such, except for the power supply pin, or the connected paired HyperTransport pins, any other pins corresponding to the bridge module and processor may be utilized as the determination pins as long as they can be used to form difference of the voltage levels by connecting to ground.

Though in the above description, the second chipset is taken as an example to explain the connections and the functions of the indicator pins, however, in practice, the indicator pins may be provided on any input/output controller, which does not have to be connected to any processor through bus. Moreover, the bridge determination pin and the ground connection pin that realized in the Land Grid Array (LGA) package as the electrical contact pin or pad, regardless it is a pin, an electrical contact point or a connection point, all belong to the sphere of Electric Contact Members. Namely, the bridge determination pin and ground connection pin belong to the sphere of Bridge Determination Contact Member or Ground Contact Member.

In addition to utilizing the hardware test method, the processor plugged onto a specific processor socket or the chipset connected to the socket may be tested directly through BIOS. Usually, the ordinary determination process is as follows: in case that a designated processor is found, then execute the normal initialization procedure; if a designated processor is not found, then test and determine further if the chipset is present, if the chipset is present, that means that the bridge module is plugged on, otherwise, that means that the processor socket is vacant. The above procedure may be used as the backup double determination procedure.

Moreover, in the following, the adjustment of the initialization procedure for computer system having the plugged on bridge module will be described in detail, which is characterized in the Link Setting of the Bus.

In the dual processor computer system having the bridge module as shown in FIGS. 5 and 6, the system framework of the Opteron™ MP processor of AMD is taken as an example. Wherein, the HyperTransport (HT) bus between the processors is called the coherent HT link (CHT link); while the HyperTransport (HT) bus between the processor and the chipset is called the non-coherent HT link (NCHT link). The basic input/output system (BIOS) is utilized to perform the initialization of the bus based mainly on the non-coherent HT link table (NCHT link table) and the coherent HT link table (CHT link table).

When a bridge module 12 is used to replace the designated processor and plugged on to the second processor socket 42, such that the designated processor can not be detected and is considered as absent. As such, the first bus 31 will not be programmed by the existing coherent HyperTransport link initialization code (refer to attachment 2) in BIOS. Thus, the contents of CHT Link Table are not changed; however, the contents of the NCHT Link Table will be changed as follows.

NCHT Link Table of dual processor computer system bridge module

| | NCHT Link 1 | |
|---|---|---|
| | (namely, the | NCHT Link 2 |
| | third bus 33) | (namely, the second bus 32) |
| NCHT Source Node | 0 (namely, | 1 → 0(designated processor |
| | processor 11) | changed to processor 11) |
| NCHT Source Link Port | 2 (link port 2 | 2 → 0 (link port 0 of |
| | of processor 11) | designated processor |
| | | changed to link port 0 of |
| | | processor 11) |
| Destination Link Bus | 0 | 128 |
| Destination Link Port | 0 | 0 |
| NCHT Link Frequency | 1000 Mhz | 1000 Mhz |
| NCHT Link Bandwidth | 16 bits | 16 bits |

In the above table 1, “the NCHT Source Node” represents the serial number of the Source Processor of a specific bus; “NCHT Link 1” indicates the third bus 33, thus “NCHT Link 2” represents the second bus 32. In FIGS. 5 and 6, the source node of the third bus 33 is processor 11 of code number 0, and the code number of the processor designated for the second processor socket 42 is 1. Upon the plugging on of the bridge module 12, since the first bus 31 and the second bus 32 both are in compliance with the data transmission protocol (for example, the HyperTransport Protocol), so that the two buses can be considered series-connected to a single bus, so that the source node of the second bus 32 is changed from the designated processor (code number 1) to processor 11 (code number 0).

Moreover, with regard to the “NCHT Source Link Port”, it is used to indicate which link port of the Source Node is utilized as the source of the bus. For example, for the AMD Opteron™ MP processor, three HyperTransport Link Ports numbered 0, 1, and 2 are utilized. In table 1, “the NCHT Source Link Port” of “the NCHT Link 1” is originally 2, which means the Link Port Number utilizing the processor 11 is 2. Originally, “the NCHT Source Link Port” of “the NCHT Link 2” is 2, that means the Link Port Number utilizing the designated processor is 2; however, upon plugging on the bridge module 12, it is changed to the connection port 0 of processor 11 utilized by the Source Node of the first bus 31.

Further, “the Destination Link Bus” and “the Destination Link Port” are related to the first and second chipsets 21 and 22, since the installation of the bridge module 12 will have no substantial effect on both of “the Destination Link Bus” and “the Destination Link Port”. Therefore, their settings in Table are not changed. The same result can be applied to “the NCHT Link Frequency” and “the NCHT bandwidth”

In other words, to the second bus 32, upon the plugging on of the bridge module 12′, in the initialization procedure only the Source information of the second bus 32 in the NCHT Link table has to be updated; in this case the Source information is the Source Node Number and the Source Link Port Number of the first bus 31.

According to one aspect of the Peripheral Component Interface (PCI), as long as the second chipset 22 keeps the same Host Bus Number, namely the Destination Link Bus is kept unchanged, and then the Register Table of the input/output device relating to the second chipset 22 may still function normally.

Yet, according to another aspect of the Advanced Configuration and Power Interface (ACPI), the second chipset 22 and the first chipset 21 may still be considered as different Root Devices, hereby the ACPI remains unchanged.

In other words, for the dual processor computer system, if one of the processors is replaced by a bridge module, then only “the NCHT Source Node” and “NCHT Source Link Port” in the NCHT Link Table need to be changed, namely the Source information of the bus is changed from the source information relating to the designated processor to that of the new source processor.

Neverthesis, for simplicity and easy explanation and understanding, the contents of the above-mentioned CHT Link Table and NCHT Link Table are not expressed in the form of the original object code of the program as stored in BIOS. However, the actual implementation of the Tables and the solution of the problem are readily understandable to those skilled in the art.

However, for the four-processor computer system as shown in FIG. 4, as the links replaced by the bridge modules 12 and 12′ both belong to the CHT links, therefore, the related contents in the CHT Link Table must adjusted accordingly.

In the following explanations and descriptions, the system utilizing four AMD Opteron™ MP Processors is taken as an example.

TABLE 2
CHT Link Table for the 4-processor computer system

| | NCHT | NCHT | NCHT | NCHT |
|---|---|---|---|---|
| | Link 1 | Link 2 | Link 3 | Link 4 |
| | (the first | (the third | (the second | (the second |
| | bus 31) | bus 31′) | bus 32) | bus 32′) |
| Source Node | 0 | 0 | 1 | 2 |
| Source Link Port | N₀ | N₀ | N₁ | N₂ |
| Destination Node | 1 | 2 | 3 | 3 |
| Destination Link | N₁ | N₂ | N₃ | N₃ |
| Port | | | | |
| Link Frequency | 1000 Mhz | 1000 Mhz | 1000 Mhz | 1000 Mhz |
| Link Bandwidth | 16 bits | 16 bits | 16 bits | 16 bits |

In Table 2, N₀, N₂, N₃ represent the Link Port Number of processors 0,1,2,3 respectively. The physical values of the respective Link Port Numbers 0, 1, 2 will not be listed here for not confusing with the serial number of the processors. As can be seen clearly from Table 2, the Source of the first bus 31 is the processor 11 on the upper right corner of FIG. 4, and its Destination is the designated processor (number 1) installed on the second processor socket 42 on the lower right corner of FIG. 4. The Source of the first bus 31′ is also the processor 11 on the upper right corner of FIG. 4, while its Destination is the designated processor (number 2) installed on the second processor socket 42′ on the upper left corner of FIG. 4. The Source of the second bus 32 is the designated processor (number 1) installed on the second processor socket 42 on the lower right corner of FIG. 4, while its Destination is the processor 11′ (number 3) on the lower left corner of FIG. 4. The Source of the second bus 32′ is the designated processor (number 2) installed on the second processor socket 42′ on the tapper left corner of FIG. 4, while its Destination is the processor 11′ (number 3) on the lower left corner of FIG. 4.

Upon installing the bridge modules 12 and 12′, the contents of CHT Link Table must be adjusted accordingly.

TABLE 3
CHT Link Table for the 4-processor computer system having 2
plugged on bridge modules

| | NCHT Link 1 | NCHT Link 2 |
|---|---|---|
| | (the first bus 31 + | (the first bus 31′ + |
| | the second bus 32) | the second bus 32′) |
| Source Node | 0 | 0 |
| Source Link Port | N₀ | N₀ |
| Destination Node | 1 | 1 |
| Destination Link Port | N₁ | N₁ |
| Link Frequency | 1000 Mhz | 1000 Mhz |
| Link Bandwidth | 16 bits | 16 bits |

Since a first bus 31 and a second bus 32 are series connected into a CHT link, that is the same case for a first bus 31′ and a second bus 32′, thus there are only two CHT links between the two processors. Due to the decrease of number of processors, thus processor re-enumeration must be performed during the initialization of the system. Therefore, the serial number of processor 11′ in Table 3 will be re-enumerated from 3 to 1, and the Destination Link Port is expressed in N₁. In this case, N₀ and N₁ include three Link Port Numbers respectively, and the Source Link Port and the Destination Link Port utilized by the two CHT links are different.

Summing up the above, in the update procedure of the CHT Link Table, firstly, in the CHT Link Table, serially combine the first buses 31, 31′ with the second buses 32, 32′ respectively, namely, to treat the first bus 31 and the second bus 32, the first bus 31′ and the second bus 32′ as a single bus respectively. Then, update all the information relating to the two combined single buses, especially the Source/Destination information, including the two source information of Source Node and the Source Link Port, and the Destination information of Destination Node and the Destination Link Port, so that the updated Source/Destination information is the respective Source/Destination information of the two single buses.

Regarding the portion of NCHT link, since the bridge modules 12 and 12′ are not connected to any NCHT link, so the change is substantially insignificant.

TABLE 4
NCHT Link Table for the 4-processor computer system

| | NCHT Link 1 | NCHT Link 2 |
|---|---|---|
| | (the third bus 33) | (the third bus 33′) |
| NCHT Source Node | 0 | 3 |
| NCHT Source Link Port | N₀ | N₃ |
| Destination Link Bus | 0 | 128 |
| Destination Link Port | 0 | 0 |
| NCHT Link Frequency | 1000 Mhz | 1000 Mhz |
| NCHT Link Bandwidth | 16 bits | 16 bits |

TABLE 5
NCHT Link Table for the 4-processor computer system having 2
installed bridge modules

| | NCHT Link 1 | NCHT Link 2 |
|---|---|---|
| | (the third bus 33) | (the third bus 33′) |
| NCHT Source Node | 0 | 1 |
| NCHT Source Link Port | N₀ | N₁ |
| Destination Link Bus | 0 | 128 |
| Destination Link Port | 0 | 0 |
| NCHT Link Frequency | 1000 Mhz | 1000 Mhz |
| NCHT Link Bandwidth | 16 bits | 16 bits |

Due to the decrease of the processor number, the processors must be re-enumerated during the initialization of the computer system, thus the serial number of processor 11′ is changed from 3 to 1. However, though in Table 5 the NCHT Source Link Port is changed from N₃ to N₁, yet it essentially is the same link port, thus its serial number is unchanged. In other words, to the third buses 33 and 33′, upon installing the bridge module 12 and 12′, only the Node serial number of the NCHT Link Table has to be changed according to the result of processor re-numeration.

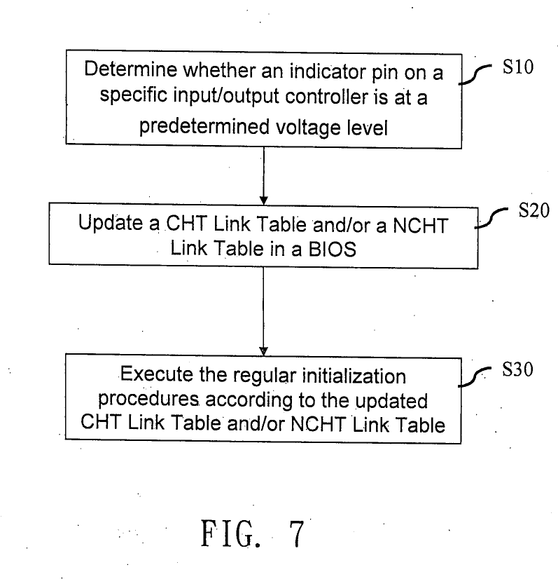

In summary, the initialization method of the computer system having bridge module disclosed by the invention includes the following extra steps except regular initialization procedures, as shown in FIG. 7. Firstly, determine whether the indicator pin on a specific input/output controller is at a predetermined voltage level (Step S10); as mentioned earlier, the predetermined voltage level can be high voltage level (1) or low voltage level (0). Next, update a Coherent HyperTransport Link Table and/or a Non-Coherent HyperTransport Link Table in the Basic Input/Output System (step S20). Namely, update the above-mentioned CHT Link Table and NCHT Link Table. And finally, execute the regular initialization procedures according to the CHT Link Table and NCHT Link Table (Step S30). In practice, all aforesaid steps and procedures for initialization may be performed through the basic input output system(BIOS) of the computer system. The term “regular initialization procedures” are easily understood for those skilled in the art, and will not be further explained for brevity.

With regard to the application of bridge modules into the computer system of 8 processors, the initialization process is performed essentially as mentioned above; the only difference is that it is more complicated.

In addition, with respect to the update of the Routing Table and the Bus Termination, since it is not the subject of the invention, thus it will not be described here for brevity. Furthermore, in the complicated standard initialization process, only the portion requiring adjustment are described in the invention, however, for the people familiar with the technology, the invention can be realized based on the above description.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer system, comprising:
at least one first processor socket and at least one second processor socket;
at least one first bus, electrically connected said first processor socket and said second processor socket;
at least one second bus, electrically connected to said second processor socket;
at least one processor, plugged onto said first processor socket and electrically connected to said first bus;
at least one bridge module, plugged onto said second processor socket and electrically connected to said first bus and said second bus, thereby enabling said processor to be electrically connected to said second bus through said first bus and said bridge module; and
at least one indicator pin of an input/output controller, when said bridge module is plugged onto said second processor socket, said indicator pin is provided with a predetermined voltage level to a BIOS of said computer system for recognition.

2. The computer system of claim 1, wherein said bridge module comprises a bridge determination contact member and a ground contact member, said bridge determination contact member is connected to said ground contact member by circuit connection.

3. The computer system of claim 2, wherein said second processor socket comprises a socket determination pin used for electrically connecting to said bridge determination contact member, said socket determination pin is connected to said indicator pin of said input/output controller by circuit connection.

4. The computer system of claim 2, wherein said bridge determination contact member and said socket determination pin are power supply pins.

5. The computer system of claim 2, wherein said ground contact member is connected to ground through said second processor socket.

6. The computer system of claim 1, wherein said indicator pin of said input/output controller is connected to a pin header by circuit connection, said pin header is used to control said predetermined voltage level of said indicator pin through a jumper.

7. The computer system of claim 6, wherein said pin header is connected to a high voltage or ground by circuit connection.

8. The computer system of claim 1, wherein said indicator pin is a general purpose input output (GPIO) pin.

9. The computer system of claim 1, wherein said predetermined voltage level is high voltage level (1) or low voltage level (0).

10. The computer system of claim 1, wherein said basic input/output system (BIOS) is imbedded into a system controller, which is connected to said input/output controller through circuit connection to form communication.

11. The computer system of claim 1, wherein said bridge module having the same package as said processor.

12. The computer system of claim 1, wherein said first bus and said second bus are both dual unidirectional point-to-point links in compliance with the same transport protocol, and transmit data without difference of master/slave.

13. The computer system of claim 1, wherein said first bus and said second bus are in compliance with the HyperTransport specification.

14. The computer system of claim 1, wherein said bridge module is provided with Pin Grid Array (PGA) package or Land Grid Array (LGA) package.

15. The computer system of claim 1, wherein said bridge module comprises a plurality of first electric contact members and a plurality of second electric contact members connected to each other respectively with the same specification as that of said processor, and the first electric contact members and the second electric contact members are electrically connected respectively to said first bus and said second bus.

16. The computer system of claim 15, wherein said first electric contact members and said second electric contact members are provided with definitions in compliance with the HyperTransport specification.

17. A bridge module, plugged onto a second processor socket on a motherboard, said second processor socket being electrically connected to a first bus and a second bus, said bridge module comprising:
a PCB (printed-circuit-board) body, plugged onto said second processor socket;
a bridge determination pin and a ground contact disposed on said PCB body, said bridge determination pin being connected to said ground contact by circuit connection;
a plurality of first electric contact members, disposed on said PCB body and connected electrically to said second processor socket to form communications with said first bus; and
a plurality of second electric contact members, disposed on said PCB body and are connected electrically to said second processor socket to form communications with said second bus;
wherein said first electric contact members and said second electric contact members are provided with certain definitions corresponding to each other for forming respective communications by circuit connections.

18. The bridge module of claim 17, wherein said second processor socket further comprises a socket determination pin electrically connected to said bridge determination pin, said socket determination pin is connected to a general purpose input output pin (GIOP) of said input/output controller through circuit connection.

19. The bridge module of claim 17, wherein said bridge determination pin is a power supply pin.

20. The bridge module of claim 17, wherein said ground contact is connected to ground via said second processor socket.

21. The bridge module of claim 17, wherein said first electric contact members and said second electric contact members are in compliance with the HyperTransport specification.

22. The bridge module of claim 17, wherein said first electric contact members and said second electric contact members are provided with Pin Grid Array (PGA) package or Land Grid Array (LGA) package.

23. The bridge module of claim 17, wherein said first electric contact members and said second electric contact members are both protruding metallic pins, or are both planar metallic pads.

24. The bridge module of claim 17, wherein said first bus and said second bus are both dual unidirectional point-to-point links in compliance with the same transport protocol, and transmit data without difference of master/slave.

25. The bridge module of claim 17, wherein said first bus and said second bus are in compliance with the HyperTransport specification.

26. The bridge module of claim 17, wherein said first bus is connected to a first processor socket, which is plugged with a processor.

27. An initialization method for a computer system, performed through a basic input output system(BIOS) of said computer system, said computer system comprising a processor plugged onto a first processor socket, and a bridge module plugged onto a second processor socket, said first processor socket and said second processor socket being electrically connected to each other through a first bus, and said second processor socket being further electrically connected to a second bus, said method comprising the following steps:
determining whether an indicator pin on an input/output controller is at a predetermined voltage level;
updating a Coherent HyperTransport Link Table and/or a Non-Coherent HyperTransport Link Table in said basic input/output system (BIOS); and
executing a plurality of regular initialization procedures according to the updated Coherent HyperTransport Link Table and/or Non-Coherent HyperTransport Link Table.

28. The method of claim 27, wherein the step of updating the Coherent HyperTransport Link Table further comprises the step of serially combining said first bus and said second bus in said Coherent HyperTransport Link Table.

29. The method of claim 28, further comprising the step of updating the source/destination information of said combined first bus and second bus in said Coherent HyperTransport Link Table.

30. The method of claim 29, wherein said updated source/destination information is the source/destination information of the single bus combined from said first bus and second bus.

31. The method of claim 29, wherein said source/destination information comprises the information concerning the Source Node, the Source Link Port, the Destination Node, and the Destination Link Port.

32. The method of claim 27, wherein the step of updating the Non-Coherent HyperTransport Link Table comprises the step of updating the Source information of said second bus in said Non-Coherent HyperTransport Link Table.

33. The method of claim 32, wherein said updated source information is the information concerning the Source Node and Source Link Port of said first bus.

34. The method of claim 27, wherein the step of updating said Coherent HyperTransport Link Table and said Non-Coherent HyperTransport Link Table further comprises the step of updating the Node Number in said Coherent HyperTransport Link Table and said Non-Coherent HyperTransport Link Table according to the result of the processor re-enumeration.
